(19) United States
(12) Patent Application Publication
(10) Pub. No.: US 2010/0191923 A1
(43) Pub. Date: Jul. 29, 2010

(54) Data Processing In A Computing Environment

(75) Inventors: Charles J. Archer, Rochester, MN (US); James E. Carey, Rochester, MN (US); Philip J. Sanders, Rochester, MN (US)

Correspondence Address: IBM (ROC-BLF), C/O BIGGERS & OHANIAN, LLP, P.O. BOX 1469, AUSTIN, TX, 78767-1469, US

(73) Assignee: INTERNATIONAL BUSINESS MACHINES CORPORATION, Armonk, NY (US)

(21) Appl. No.: 12/361,943

(22) Filed: Jan. 29, 2009

(51) Int. Cl. G06F 12/00

(52) U.S. Cl. 711/154; 711/E12.001

(57) ABSTRACT

Methods, apparatus, and products for data processing in a computing environment including allocating, by an operating system for an application, a virtual address spaces with each virtual address space mapped to a same physical address space and each virtual address space associated with an operation; receiving, from the application, an instruction to store a value in a specific virtual address, the specific virtual address contained within one of the allocated virtual address spaces; identifying a physical address associated with the specific virtual address; performing, with the value and the contents of the identified physical address, the operation associated with the virtual address space containing the specific virtual address; and storing a result of the operation in the identified physical address.

### BACKGROUND OF THE INVENTION

1. Field of the Invention

The field of the invention is data processing, or, more specifically, methods, apparatus, and products for data processing in a computing environment.

2. Description Of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output (‘I/O’) devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Computer systems today have advanced such that some computing environments now include core components of different architectures which operate together to complete data processing tasks. Such computing environments are described in this specification as ‘hybrid’ environments, denoting that such environments include host computers and accelerators having different architectures. Although hybrid computing environments are more computationally powerful and efficient in data processing than many non-hybrid computing environments, such hybrid computing environments still present substantial challenges to the science of automated computing machinery.

### SUMMARY OF THE INVENTION

Methods, apparatus, and products for data processing in a computing environment including allocating, by an operating system for an application, virtual address spaces with each virtual address space mapped to a same physical address space and each virtual address space associated with an operation; receiving, from the application, an instruction to store a value in a specific virtual address, the specific virtual address contained within one of the allocated virtual address spaces; identifying a physical address associated with the specific virtual address; performing, with the value and the contents of the identified physical address, the operation associated with the virtual address space containing the specific virtual address; and storing a result of the operation in the identified physical address.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a diagram of an example hybrid computing environment useful for data processing according to embodiments of the present invention.

FIG. 2 sets forth a block diagram of an exemplary hybrid computing environment useful for data processing according to embodiments of the present invention.

FIG. 3 sets forth a block diagram of a further exemplary hybrid computing environment useful for data processing according to embodiments of the present invention.

FIG. 4 sets forth a block diagram of a further exemplary hybrid computing environment useful for data processing according to embodiments of the present invention.

FIG. 5 sets forth a flow chart illustrating an exemplary method for data processing in a computing environment according to embodiments of the present invention.

FIG. 6 sets forth a flow chart illustrating a further exemplary method for data processing in a computing environment according to embodiments of the present invention.

FIG. 7 sets forth a flow chart illustrating a further exemplary method for data processing in a computing environment according to embodiments of the present invention.

### DETAILED DESCRIPTION OF EXEMPLARY EMBODIMENTS

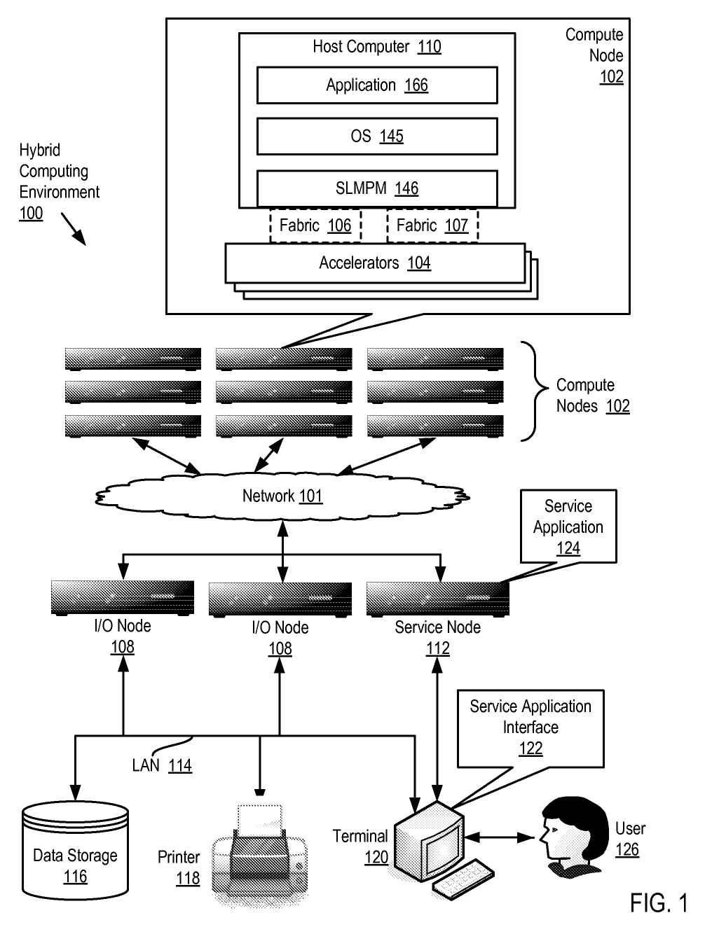

Exemplary methods, apparatus, and products for data processing in a computing environment according to embodiments of the present invention are described with reference to the accompanying drawings, beginning with FIG. 1. FIG. 1 sets forth a diagram of an example hybrid computing environment (100) useful for data processing according to embodiments of the present invention. A ‘hybrid computing environment,’ as the term is used in this specification, is a computing environment in that it includes computer processors operatively coupled to computer memory so as to implement data processing in the form of execution of computer program instructions stored in the memory and executed on the processors. In addition, the hybrid computing environment (100) in the example of FIG. 1 includes at least one host computer having a host architecture that operates in cooperation with an accelerator having an accelerator architecture where the host architecture and accelerator architecture are different architectures. The host and accelerator architectures in this example are characterized by architectural registers, registers that are accessible by computer program instructions that execute on each architecture, registers such as, for example, an instruction register, a program counter, memory index registers, stack pointers, and the like. That is, the number, type, structure, and relations among the architectural registers of the two architectures are different, so different that computer program instructions compiled for execution on the host computer of a hybrid computing environment typically cannot be executed natively by any associated accelerator of the hybrid computing environment.

Examples of hybrid computing environments include a data processing system that in turn includes one or more host computers, each having an x86 processor, and accelerators whose architectural registers implement the PowerPC instruction set. Computer program instructions compiled for execution on the x86 processors in the host computers cannot be executed natively by the PowerPC processors in the accelerators. Readers will recognize in addition that some of the example hybrid computing environments described in this specification are based upon the Los Alamos National Laboratory (‘LANL’) supercomputer architecture developed in the LANL Roadrunner project (named for the state bird of New Mexico), the supercomputer architecture that famously first generated a ‘petaflop,’ a million billion floating point operations per second. The LANL supercomputer architecture includes many host computers with dual-core AMD Opteron processors coupled to many accelerators with IBM Cell processors, the Opteron processors and the Cell processors having different architectures.

The example hybrid computing environment (100) of FIG. 1 includes a plurality of compute nodes (102), I/O nodes (108), and a service node (112). The compute nodes (102) are coupled through network (101) for data communications with one another and with the I/O nodes (108) and the service node (112). The data communications network (101) may be implemented as an Ethernet, Internet Protocol (‘IP’), PCIe, Infiniband, Fibre Channel, or other network as will occur to readers of skill in the art.

In the example hybrid computing environment (100) of FIG. 1, the compute nodes carry out principal user-level computer program execution, accepting administrative services, such as initial program loads and the like, from the service application (124) executing on the service node (112) and gaining access to data storage (116) and I/O functionality (118, 120) through the I/O nodes (108). In the example of FIG. 1, the I/O nodes (108) are connected for data communications to I/O devices (116, 118, 120) through a local area network (‘LAN’) (114) implemented using high-speed Ethernet or a data communications fabric of another fabric type as will occur to those of skill in the art. I/O devices in the example hybrid computing environment (100) of FIG. 1 include non-volatile memory for the computing environment in the form of data storage device (116), an output device for the hybrid computing environment in the form of printer (118), and a user (126) I/O device in the form of computer terminal (120) that executes a service application interface (122) that provides to a user an interface for configuring compute nodes in the hybrid computing environment and initiating execution by the compute nodes of principal user-level computer program instructions.

In the example of FIG. 1, each compute node includes a host computer (110) having a host computer architecture and one or more accelerators (104) having an accelerator architecture. A host computer (110) is a ‘host’ in the sense that it is the host computer that carries out interface functions between a compute node and other components of the hybrid computing environment external to any particular compute node. That is, it is the host computer that executes initial boot procedures, power on self tests, basic I/O functions, accepts user-level program loads from service nodes, and so on. An accelerator (104) is an ‘accelerator’ in that each accelerator has an accelerator architecture that is optimized, with respect to the host computer architecture, for speed of execution of a particular class of computing functions. Such accelerated computing functions include, for example, vector processing, floating point operations, and others as will occur to those of skill in the art.

Because each of the compute nodes in the example of FIG. 1 includes a host computer and an accelerator, readers of skill in the art will recognize that each compute node represents a smaller, separate hybrid computing environment within the larger hybrid computing environment (100) of FIG. 1. That is, not only may the combination of the compute nodes (102) form a hybrid computing environment (100), but it is also the case that each individual compute node may also be viewed as a separate, smaller hybrid computing environment. The hybrid computing environment (100) in the example of FIG. 1 then, may be viewed as composed of nine separate, smaller hybrid computing environments, one for each compute node, which taken together form the hybrid computing environment (100) of FIG. 1.

Within each compute node (102) of FIG. 1, a host computer (110) and one or more accelerators (104) are adapted to one another for data communications by a system level message passing module (‘SLMPM’) (146) and by two or more data communications fabrics (106, 107) of at least two different fabric types. An SLMPM (146) is a module or library of computer program instructions that exposes an application programming interface (‘API’) to user-level applications for carrying out message-based data communications between the host computer (110) and the accelerator (104). Examples of message-based data communications libraries that may be improved for use as an SLMPM according to embodiments of the present invention include:
the Message Passing Interface or ‘MPI,’ an industry standard interface in two versions, first presented at Supercomputing 1994, not sanctioned by any major standards body,
the Data Communication and Synchronization interface (‘DACS’) of the LANL supercomputer,
the POSIX Threads library (‘Pthreads’), an IEEE standard for distributed, multithreaded processing,
the Open Multi-Processing interface (‘OpenMP’), an industry-sanctioned specification for parallel programming, and
other libraries that will occur to those of skill in the art.

A data communications fabric (106, 107) is a configuration of data communications hardware and software that implements a data communications coupling between a host computer and an accelerator. Examples of data communications fabric types include Peripheral Component Interconnect (‘PCI’), PCI express (‘PCIe’), Ethernet, Infiniband, Fibre Channel, Small Computer System Interface (‘SCSI’), External Serial Advanced Technology Attachment (‘eSATA’), Universal Serial Bus (‘USB’), and so on as will occur to those of skill in the art.

The hybrid computing environment (100) of FIG. 1 is one example of a computing environment configured for data processing according to embodiments of the present invention. Data processing in the hybrid computing environment (100) of FIG. 1 according to embodiments of the present invention may include allocating, by an operating system (145) by for an application (166), a plurality of virtual address spaces where each virtual address space is mapped to a same physical address space and each virtual address space is associated with an operation; receiving, from the application (166), an instruction to store a value in a specific virtual address where the specific virtual address is contained within one of the allocated virtual address spaces; identifying a physical address associated with the specific virtual address; performing, with the value and the contents of the identified physical address, the operation associated with the virtual address space containing the specific virtual address; and storing a result of the operation in the identified physical address.

The arrangement of compute nodes, data communications fabrics, networks, I/O devices, service nodes, I/O nodes, and so on, making up the hybrid computing environment (100) as illustrated in FIG. 1 are for explanation only, not for limitation of the present invention. Hybrid computing environments capable of data processing according to embodiments of the present invention may include additional or fewer nodes, networks, devices, and architectures, not shown in FIG. 1, as will occur to those of skill in the art. In fact, data processing according to embodiments of the present invention need not be carried out in a hybrid computing environment as such, but in any computing environment configured for such data processing. Although the hybrid computing environment (100) in the example of FIG. 1 includes only nine compute nodes (102), readers will note that hybrid computing environments according to embodiments of the present invention may include any number of compute nodes. The LANL supercomputer, taken as an example of a hybrid computing environment with multiple compute nodes, contains as of this writing more than 12,000 compute nodes. Networks and data communications fabrics in such hybrid computing environments may support many data communications protocols including for example TCP (Transmission Control Protocol), IP (Internet Protocol), and others as will occur to those of skill in the art. Various embodiments of the present invention may be implemented on a variety of hardware platforms in addition to those illustrated in FIG. 1.

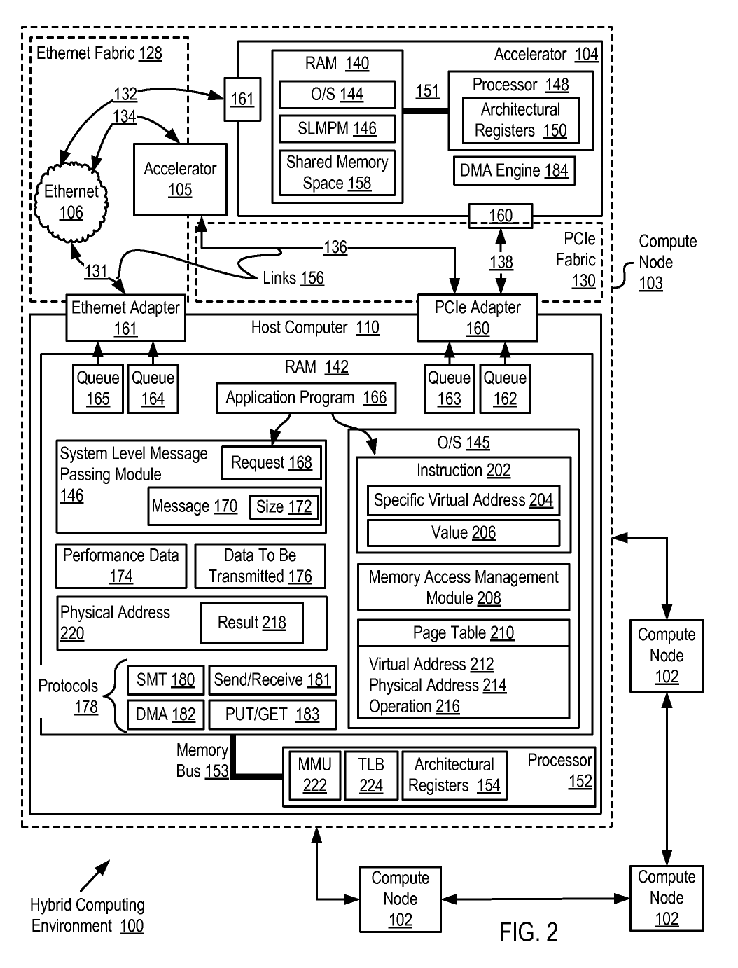

For further explanation, FIG. 2 sets forth a block diagram of an exemplary hybrid computing environment (100) useful for data processing according to embodiments of the present invention. The hybrid computing environment (100) of FIG. 2 includes four compute nodes. Similar to the compute nodes of FIG. 1, each of the compute nodes in the example of FIG. 2 may represent a small, separate hybrid computing environment which taken together make up a larger hybrid computing environment. One compute node (103) in the example of FIG. 2 is illustrated in an expanded view to aid a more detailed explanation of such a hybrid computing environment (100). As shown in the expanded view of compute node (103), each of the compute nodes (102, 103) in the example of FIG. 2 includes a host computer (110). The host computer (110) includes a computer processor (152) operatively coupled to computer memory, Random Access Memory (‘RAM’) (142), through a high speed memory bus (153). The processor (152) in each host computer (110) has a set of architectural registers (154) that defines the host computer architecture.

Each of the compute nodes also includes one or more accelerators (104, 105). Each accelerator (104, 105) includes a computer processor (148) operatively coupled to RAM (140) through a high speed memory bus (151). Stored in RAM (140,142) of the host computer and the accelerators (104, 105) is an operating system (145). Operating systems useful in host computers and accelerators of hybrid computing environments according to embodiments of the present invention include UNIX™, Linux™, Microsoft XP™, Microsoft Vista™, Microsoft NT™, AIX™, IBM's i5/OS™, and others as will occur to those of skill in the art. There is no requirement that the operating system in the host computers should be the same operating system used on the accelerators.

The processor (148) of each accelerator (104, 105) has a set of architectural registers (150) that defines the accelerator architecture. The architectural registers (150) of the processor (148) of each accelerator are different from the architectural registers (154) of the processor (152) in the host computer (110). With differing architectures, it would be uncommon, although possible, for a host computer and an accelerator to support the same instruction sets. As such, computer program instructions compiled for execution on the processor (148) of an accelerator (104) generally would not be expected to execute natively on the processor (152) of the host computer (110) and vice versa. Moreover, because of the typical differences in hardware architectures between host processors and accelerators, computer program instructions compiled for execution on the processor (152) of a host computer (110) generally would not be expected to execute natively on the processor (148) of an accelerator (104) even if the accelerator supported the instruction set of the host. The accelerator architecture in example of FIG. 2 is optimized, with respect to the host computer architecture, for speed of execution of a particular class of computing functions. That is, for the function or functions for which the accelerator is optimized, execution of those functions will proceed faster on the accelerator than if they were executed on the processor of the host computer.

In the example of FIG. 2, the host computer (110) and the accelerators (104, 105) are adapted to one another for data communications by a system level message passing module (‘SLMPM’) (146) and two data communications fabrics (128, 130) of at least two different fabric types. In this example, to support message-based data communications between the host computer (110) and the accelerator (104), both the host computer (110) and the accelerator (104) have an SLMPM (146) so that message-based communications can both originate and be received on both sides of any coupling for data communications. Also in the example of FIG. 2, the host computer (110) and the accelerators (104, 105) are adapted to one another for data communications by a PCIe fabric (130) through PCIe communications adapters (160) and an Ethernet fabric (128) through Ethernet communications adapters (161). The use of PCIe and Ethernet is for explanation, not for limitation of the invention. Readers of skill in the art will immediately recognize that hybrid computing environments according to embodiments of the present invention may include fabrics of other fabric types such as, for example, PCI, Infiniband, Fibre Channel, SCSI, eSATA, USB, and so on.

The SLMPM (146) in this example operates generally for data processing in a computing environment (100) according to embodiments of the present invention by monitoring data communications performance for a plurality of data communications modes between the host computer (110) and the accelerators (104, 105), receiving a request (168) to transmit data according to a data communications mode from the host computer to an accelerator, determining whether to transmit the data according to the requested data communications mode, and if the data is not to be transmitted according to the requested data communications mode: selecting another data communications mode and transmitting the data according to the selected data communications mode. In the example of FIG. 2, the monitored performance is illustrated as monitored performance data (174) stored by the SLMPM (146) in RAM (142) of the host computer (110) during operation of the compute node (103).

A data communications mode specifies a data communications fabric type, a data communications link, and a data communications protocol (178). A data communications link (156) is data communications connection between a host computer and an accelerator. In the example of FIG. 2, a link (156) between the host computer (110) and the accelerator (104) may include the PCIe connection (138) or the Ethernet connection (131, 132) through the Ethernet network (106). A link (156) between the host computer (110) and the accelerator (105) in the example of FIG. 2 may include the PCIe connection (136) or the Ethernet connection (131, 134) through the Ethernet network (106). Although only one link for each fabric type is illustrated between the host computer and the accelerator in the example of FIG. 2, readers of skill in the art will immediately recognize that there may any number of links for each fabric type.

A data communications protocol is a set of standard rules for data representation, signaling, authentication and error detection required to send information from a host computer (110) to an accelerator (104). In the example of FIG. 2, the SLMPM (146) may select one of several protocols (178) for data communications between the host computer (110) and the accelerator. Examples of such protocols (178) include shared memory transfers (‘SMT’) (180) executed with a send and receive operations (181), and direct memory access (‘DMA’) (182) executed with PUT and GET operations (183).

Shared memory transfer is a data communications protocol for passing data between a host computer and an accelerator into shared memory space (158) allocated for such a purpose such that only one instance of the data resides in memory at any time.

Consider the following as an example shared memory transfer between the host computer (110) and the accelerator (104) of FIG. 2. An application (166) requests (168) a transmission of data (176) from the host computer (110) to the accelerator (104) in accordance with the SMT (180) protocol. Such a request (168) may include a memory address allocated for such shared memory. In this example, the shared memory segment (158) is illustrated in a memory location on the accelerator (104), but readers will recognize that shared memory segments may be located on the accelerator (104), on the host computer (110), on both the host computer and the accelerator, or even off the local compute node (103) entirely—so long as the segment is accessible as needed by the host and the accelerator. To carry out a shared memory transfer, the SLMPM (146) on the host computer (110) establishes a data communications connection with the SLMPM (146) executing on the accelerator (104) by a handshaking procedure similar to that in the TCP protocol. The SLMPM (146) then creates a message (170) that includes a header and a payload data and inserts the message into a message transmit queue for a particular link of a particular fabric. In creating the message, the SLMPM inserts, in the header of the message, an identification of the accelerator and an identification of a process executing on the accelerator. The SLMPM also inserts the memory address from the request (168) into the message, either in the header or as part of the payload data. The SLMPM also inserts the data (176) to be transmitted in the message (170) as part of the message payload data. The message is then transmitted by a communications adapter (160, 161) across a fabric (128, 130) to the SLMPM executing on the accelerator (104) where the SLMPM stores the payload data, the data (176) that was transmitted, in shared memory space (158) in RAM (140) in accordance with the memory address in the message.

Direct memory access (‘DMA’) is a data communications protocol for passing data between a host computer and an accelerator with reduced operational burden on the computer processor (152). A DMA transfer essentially effects a copy of a block of memory from one location to another, typically from a host computer to an accelerator or vice versa. Either or both a host computer and accelerator may include DMA engine, an aggregation of computer hardware and software for direct memory access. Direct memory access includes reading and writing to memory of accelerators and host computers with reduced operational burden on their processors. A DMA engine of an accelerator, for example, may write to or read from memory allocated for DMA purposes, while the processor of the accelerator executes computer program instructions, or otherwise continues to operate. That is, a computer processor may issue an instruction to execute a DMA transfer, but the DMA engine, not the processor, carries out the transfer.

In the example of FIG. 2, only the accelerator (104) includes a DMA engine (184) while the host computer does not. In this embodiment the processor (152) on the host computer initiates a DMA transfer of data from the host to the accelerator by sending a message according to the SMT protocol to the accelerator, instructing the accelerator to perform a remote ‘GET’ operation. The configuration illustrated in the example of FIG. 2 in which the accelerator (104) is the only device containing a DMA engine is for explanation only, not for limitation. Readers of skill in the art will immediately recognize that in many embodiments, both a host computer and an accelerator may include a DMA engine, while in yet other embodiments only a host computer includes a DMA engine.

To implement a DMA protocol in the hybrid computing environment of FIG. 2 some memory region is allocated for access by the DMA engine. Allocating such memory may be carried out independently from other accelerators or host computers, or may be initiated by and completed in cooperation with another accelerator or host computer. Shared memory regions, allocated according to the SMA protocol, for example, may be memory regions made available to a DMA engine. That is, the initial setup and implementation of DMA data communications in the hybrid computing environment (100) of FIG. 2 may be carried out, at least in part, through shared memory transfers or another out-of-band data communications protocol, out-of-band with respect to a DMA engine. Allocation of memory to implement DMA transfers is relatively high in latency, but once allocated, the DMA protocol provides for high bandwidth data communications that requires less processor utilization than many other data communications protocols.

A direct ‘PUT’ operation is a mode of transmitting data from a memory location on an origin device to a memory location on a target device through a DMA engine. A direct ‘PUT’ operation allows data to be transmitted and stored on the target device with little involvement from the target device's processor. To effect minimal involvement from the target device's processor in the direct ‘PUT’ operation, the DMA engine transfers the data to be stored on the target device along with a specific identification of a storage location on the target device. The DMA engine knows the specific storage location on the target device because the specific storage location for storing the data on the target device has been previously provided by the target device.

A remote ‘GET’ operation, sometimes denominated an ‘rGET,’ is another mode of transmitting data from a memory location on an origin device to a memory location on a target device through a DMA engine. A remote ‘GET’ operation allows data to be transmitted and stored on the target device with little involvement from the origin device's processor. To effect minimal involvement from the origin device's processor in the remote ‘GET’ operation, the DMA engine stores the data in a storage location accessible one the target device, notifies the target device, directly or out-of-band through a shared memory transmission, of the storage location and the size of the data ready to be transmitted, and the target device retrieves the data from the storage location.

Monitoring data communications performance for a plurality of data communications modes may include monitoring a number of requests (168) in a message transmit request queue (162-165) for a data communications link (156). In the example of FIG. 2, each message transmit request queue (162-165) is associated with one particular data communications link (156). Each queue (162-165) includes entries for messages (170) that include data (176) to be transmitted by the communications adapters (160, 161) along a data communications link (156) associated with queue.

Monitoring data communications performance for a plurality of data communications modes may also include monitoring utilization of a shared memory space (158). In the example of FIG. 2, shared memory space (158) is allocated in RAM (140) of the accelerator. Utilization is the proportion of the allocated shared memory space to which data has been stored for sending to a target device and has not yet been read or received by the target device, monitored by tracking the writes and reads to and from the allocated shared memory. In the hybrid computing environment (100) of FIG. 2, shared memory space, any memory in fact, is limited. As such, a shared memory space (158) may be filled during execution of an application program (166) such that transmission of data from the host computer (110) to an accelerator may be slowed, or even stopped, due to space limitations in the shared memory space.

In some embodiments of the present invention, the hybrid computing environment (100) of FIG. 2 may be configured to operate as a parallel computing environment in which two or more instances the application program (166) executes on two or more host computers (110) in the parallel computing environment. In such embodiments, monitoring data communications performance across data communications modes may also include aggregating data communications performance information (174) across a plurality of instances of the application program (166) executing on two or more host computers in a parallel computing environment. The aggregated performance information (174) may be used to calculate average communications latencies for data communications modes, average number of requests in data communications links of a particular fabric type, average shared memory utilization among the plurality of host computers and accelerators in the parallel computing environment, and so on as will occur to those of skill in the art. Any combination of such measures may be used by the SLMPM for both determining whether to transmit the data according to requested data communications mode and selecting another data communications mode for transmitting the data if the data is not to be transmitted according to the requested data communications mode.

The SLMPM (146) of FIG. 2 receives, from an application program (166) on the host computer (110), a request (168) to transmit data (176) according to a data communications mode from the host computer (110) to the accelerator (104). Such data (176) may include computer program instructions compiled for execution by the accelerator (104), work piece data for an application program executing on the accelerator (104), or some combination of computer program instructions and work piece data. Receiving a request (168) to transmit data (176) according to a data communications mode may include receiving a request to transmit data by a specified fabric type, receiving a request to transmit data through a specified data communications link from the host computer to the accelerator, or receiving a request to transmit data from the host computer to the accelerator according to a protocol.

A request (168) to transmit data (176) according to a data communications mode may be implemented as a user-level application function call through an API to the SLMPM (146), a call that expressly specifies a data communications mode according to protocol, fabric type, and link. A request implemented as a function call may specify a protocol according to the operation of the function call itself. A dacs_put( ) function call, for example, may represent a call through an API exposed by an SLMPM implemented as a DACS library to transmit data in the default mode of a DMA ‘PUT’ operation. Such a call, from the perspective of the calling application and the programmer who wrote the calling application, represents a request to the SLMPM library to transmit data according to the default mode, known to the programmer to be default mode associated with the express API call. The called function, in this example dacs_put( ), may be coded according to embodiments of the present invention, to make its own determination whether to transmit the data according to the requested data communications mode, that is, according to the default mode of the called function. In a further example, a dacs_send( ) instruction may represent a call through an API exposed by an SLMPM implemented as a DACS library to transmit data in the default mode of an SMT ‘send’ operation, where the called function dacs_send( ) is again coded according to embodiments of the present invention to make its own determination whether to transmit the data according to the requested mode.

An identification of a particular accelerator in a function call may effectively specify a fabric type. Such a function call may include as a call parameters an identification of a particular accelerator. An identification of a particular accelerator by use of a PCIe ID, for example, effectively specifies a PCI fabric type. In another, similar, example, an identification of a particular accelerator by use of a media access control (‘MAC’) address of an Ethernet adapter effectively specifies the Ethernet fabric type. Instead of implementing the accelerator ID of the function call from an application executing on the host in such a way as to specify a fabric type, the function call may only include a globally unique identification of the particular accelerator as a parameter of the call, thereby specifying only a link from the host computer to the accelerator, not a fabric type. In this case, the function called may implement a default fabric type for use with a particular protocol. If the function called in the SLMPM is configured with PCIe as a default fabric type for use with the DMA protocol, for example, and the SLMPM receives a request to transmit data to the accelerator (104) according to the DMA protocol, a DMA PUT or DMA remote GET operation, the function called explicitly specifies the default fabric type for DMA, the PCIe fabric type.

In hybrid computing environments in which only one link of each fabric type adapts a single host computer to a single accelerator, the identification of a particular accelerator in a parameter of a function call, may also effectively specify a link. In hybrid computing environments where more than one link of each fabric type adapts a host computer and an accelerator, such as two PCIe links connecting the host computer (110) to the accelerator (104), the SLMPM function called may implement a default link for the accelerator identified in the parameter of the function call for the fabric type specified by the identification of the accelerator.

The SLMPM (146) in the example of FIG. 2 also determines, in dependence upon the monitored performance (174), whether to transmit the data (176) according to the requested data communications mode. Determining whether to transmit the data (176) according to the requested data communications mode may include determining whether to transmit data by a requested fabric type, whether to transmit data through a requested data communications link, or whether to transmit data according to a requested protocol.

In hybrid computing environments according to embodiments of the present invention, where monitoring data communications performance across data communications modes includes monitoring a number of requests in a message transmit request queue (162-165) for a data communications link, determining whether to transmit the data (176) according to the requested data communications mode may be carried out by determining whether the number of requests in the message transmit request queue exceeds a predetermined threshold. In hybrid computing environments according to embodiments of the present invention, where monitoring data communications performance for a plurality of data communications modes includes monitoring utilization of a shared memory space, determining whether to transmit the data (176) according to the requested data communications mode may be carried out by determining whether the utilization of the shared memory space exceeds a predetermined threshold.

If the data is not to be transmitted according to the requested data communications mode, the SLMPM (146) selects, in dependence upon the monitored performance, another data communications mode for transmitting the data and transmits the data (176) according to the selected data communications mode. Selecting another data communications mode for transmitting the data may include selecting, in dependence upon the monitored performance, another data communications fabric type by which to transmit the data, selecting a data communications link through which to transmit the data, and selecting another data communications protocol. Consider as an example, that the requested data communications mode is a DMA transmission using a PUT operation through link (138) of the PCIe fabric (130) to the accelerator (104). If the monitored data performance (174) indicates that the number of requests in transmit message request queue (162) associated with the link (138) exceeds a predetermined threshold, the SLMPM may select another fabric type, the Ethernet fabric (128), and link (131, 132) through which to transmit the data (176). Also consider that the monitored performance (176) indicates that current utilization of the shared memory space (158) is less than a predetermined threshold while the number of outstanding DMA transmissions in the queue (162) exceeds a predetermined threshold. In such a case, the SLMPM (146) may also select another protocol, such as a shared memory transfer, by which to transmit the data (174).

Selecting, by the SLMPM, another data communications mode for transmitting the data (172) may also include selecting a data communications protocol (178) in dependence upon data communications message size (172). Selecting a data communications protocol (178) in dependence upon data communications message size (172) may be carried out by determining whether a size of a message exceeds a predetermined threshold. For larger messages (170), the DMA protocol may be a preferred protocol as processor utilization in making a DMA transfer of a larger message (170) is typically less than the processor utilization in making a shared memory transfer of a message of the same size.

As mentioned above, the SLMPM may also transmit the data according to the selected data communications mode. Transmit the data according to the selected data communications mode may include transmitting the data by the selected data communications fabric type, transmitting the data through the selected data communications link, or transmitting the data according to the selected protocol. The SLMPM (146) may effect a transmission of the data according to the selected data communications mode by instructing, through a device driver, the communications adapter for the data communications fabric type of the selected data communications mode to transmit the message (170) according to a protocol of the selected data communications mode, where the message includes in a message header, an identification of the accelerator, and in the message payload, the data (176) to be transmitted.

The example hybrid computing environment (100) of FIG. 2 may operate generally for data processing by allocating, by an operating system (145) for an application (166), virtual address spaces. The virtual address spaces in the example hybrid computing environment of FIG. 2 are mapped to a same physical address space and each virtual address space is also associated with an operation. Data processing in the hybrid computing environment (100) of FIG. 2 in accordance with embodiments of the present invention may also include receiving, from the application (166), an instruction (202) to store a value (206) in a specific virtual address (204). In the example hybrid computing environment of FIG. 2 the specific virtual address (204) is contained within one of the allocated virtual address spaces. Data processing in the hybrid computing environment (100) of FIG. 2 in accordance with embodiments of the present invention may also include identifying a physical address (220) associated with the specific virtual address (204); performing, with the value (206) and the contents of the identified physical address (220), the operation (216) associated with the virtual address space containing the specific virtual address (204); and storing a result (218) of the operation in the identified physical address (220).

A virtual address space is a range of virtual memory addresses. A physical address space is a range of physical memory addresses. In contrast to prior art mappings of virtual address spaces to physical address spaces where one physical address in a physical address space is mapped to only one virtual address, multiple virtual address spaces in the example computing environment of FIG. 2 may be mapped in accordance with embodiments of the present invention to the same physical address space. That is, one virtual address in each of the multiple virtual address spaces is mapped to single physical address. Consider, as an example of virtual addresses from different virtual spaces that map to a single physical address, a virtual address 0x1000 in one virtual address space and virtual address 0x10000 in another virtual address space each map to a single physical address 0x100.

An ‘operation’ associated with a virtual address as the term is used here, is a logical operation, a mathematical operation, or other type of operation, that is carried out responsive to a store instruction to a virtual address that is included in the virtual address space associated with that operation. Consider as an example that the virtual address range 0x000 to 0x100 is associated with an addition operation. Any store instruction from the application to a virtual address within the memory address range 0x000 to 0x100 effects an execution of an addition operation where the value included in the store operation is added to the contents stored at the physical address associated with virtual address of the store instruction. After the execution of the addition operation, the result is then stored in the physical address.

The operating system (145) of the host computer (110) in the example hybrid computing environment (100) of FIG. 2 may allocate such virtual address spaces for an application (166) at the behest of the application by associating in a page table (210) each virtual address (212) of the virtual address spaces with a physical address (214) and an operation (216). Allocating such virtual address spaces may also include associating each virtual address (212) of a virtual address space with a physical address (214) and an operation (216) in an architectural register of a processor that implements a translation lookaside buffer (224) used by a memory management unit (222). A page table of the prior art is a data structure used to store mappings between virtual addresses and physical addresses. That is, prior art page tables do not map virtual addresses to operations. A page table (210) used by an operating system according to embodiments of the present invention, however, may be improved in comparison to prior art page tables by mapping virtual addresses to operations to be performed. A translation lookaside buffer of the prior art (‘TLB’) may be implemented as a computer processor cache that is used by a memory management unit to improve speed of virtual address translation. TLBs of the prior art have a fixed number of slots containing page table entries which map virtual addresses onto physical addresses. Like page tables of the prior art, TLBs of the prior art do not map virtual addresses to operations to be performed. A translation lookaside buffer (224) used by a memory management unit (222) for data processing in accordance with embodiments of the present invention may be improved to map virtual addresses to operations to be performed. An application may request an allocation of such virtual address spaces with a system level function call to a designated allocation function used specifically to designate an operation for each virtual address space allocated for an application in addition to allocating virtual memory for the application. Such a system level function call may include as arguments for the function call, an identification of one or more operations and a requested size of memory to allocate. Although virtual addresses, physical addresses, and operations are associated in the example hybrid computing environment of FIG. 2 in either a single page table (210) or a single translation lookaside buffer (224), readers of skill in the art will immediately recognize that greater or fewer data structures, lists, tables, and like, may be used to represent such associations. Consider as an example, a first table that associates virtual address spaces with operations and a second table, a page table (210) or translation lookaside buffer (224) similar to those of the prior art, that associates virtual addresses with physical addresses.

In the example hybrid computing environment (100) of FIG. 2, receiving, from the application (166), an instruction (202) to store a value (206) in a specific virtual address (204) may be carried out by the operating system (145) of the host computer (110) as depicted, by a memory management unit (222) implemented as computer hardware, by the system level message passing module (146) executing on the host computer (110), by a memory access management module (208) implemented as a software component of the operation system (145) or as a standalone software module, or by other computer hardware or software modules as may occur to those of skill in the art. Receiving such an instruction may include receiving a function call that includes as elements of the call, a virtual address and the value. Receiving such an instruction may also include determining whether the specific virtual address (204) is associated with an operation by finding in the page table (210) of the operating system (145) or in the translation lookaside buffer (224) of the memory management unit (222), a record for the virtual address that identifies the operation associated with the specific virtual address (204).

In the example hybrid computing environment (100) of FIG. 2, receiving, from the application (166), an instruction (202) to store a value (206) in a specific virtual address (204) may be carried out by the operating system (145) of the host computer (110) as depicted, by a memory management unit (222) implemented as computer hardware, by the system level message passing module (146) executing on the host computer (110), or by other computer hardware or software modules as may occur to those of skill in the art.

In the example hybrid computing environment (100) of FIG. 2, identifying a physical address associated with the specific virtual address may be carried out by the operating system (145) of the host computer (110), by a memory management unit (222) implemented as computer hardware, by the system level message passing module (146) executing on the host computer (110), by a memory access management module (208) implemented as a software component of the operation system (145) or as a standalone software module, or by other computer hardware or software modules as may occur to those of skill in the art. Identifying a physical address (220) associated with the specific virtual address (204) may be carried out by searching the page table (210), by the operating system, or searching the translation lookaside buffer (224) by the memory management unit (222), for the physical address associated with the specific virtual address.

In the example hybrid computing environment (100) of FIG. 2, performing the operation (216) associated with the virtual address space containing the specific virtual address (204) and storing a result of the operation in the identified physical address may be carried out by the operating system (145) of the host computer (110), by a memory management unit (222) implemented as computer hardware, by the system level message passing module (146) executing on the host computer (110), by the system level message passing module (146) executing on the accelerator (104), by computer software or hardware of the accelerator (104), by a memory access management module (208) implemented as a software component of the operation system (145) or as a standalone software module, or by other computer hardware or software modules as may occur to those of skill in the art. Performing the operation (216) associated with the virtual address space containing the specific virtual address (204) and storing the result of the operation may be carried out reading the contents of the physical address (220) from memory (142), executing the logical, mathematic, or other operation (216) with the value (206) and the read contents of the physical address, and writing the result (218) of the operation to memory (142) at the physical address (220). Consider as an example that the operation is addition, the value is 20, and the contents of the physical address include a value of 40. Performing the operation (216) in such an example may be carried by reading the contents of the physical address, 40, from memory, adding 40 to the value, 20, and storing the result of the addition, 60, at the physical address in memory.

In some computing environments configured for data processing according to embodiments of the present invention, receiving, from an application, an instruction to store a value in a specific virtual address may include intercepting, by a memory access management module (208), the instruction to store the value in the specific virtual address. A memory access management module is a module of computer program instructions capable of intercepting store instructions from applications. Such a module may be implemented in various ways, as a standalone software module, as a software component of an operating system, as a software component of a system level message passing module (146), and in other ways as will occur to those of skill in the art. Intercepting, by a memory access management module (208), the instruction to store the value in the specific virtual address may be carried out by monitoring a processor register implementing an instruction stack pointer for an address associated with the store instruction or in other ways as may occur to readers of skill in the art. In computing environments in which a memory access management module intercept store instructions (202), identifying the physical address (220), performing the operation, and storing the result (218) of the operation in the identified physical address (220) may also be carried out in software by the memory access management module (208).

In computing environments configured for data processing according to embodiments which are implemented as hybrid computing environments (100) like that in the example of FIG. 2, receiving, from an application, an instruction (202) to store a value (206) in a specific virtual address (204) may include receiving, by the SLMPM (146), the instruction (202) from a host application program (166) executing on the host computer (110) and the SLMPM (146) may instruct the accelerator to perform the operation and store the result in the physical address (220). The physical address (220) may be an address of memory within a shared memory space (158) on the accelerator (104).

Receiving, by the SLMPM (146), the instruction (202) from a host application program (166) executing on the host computer (110) may be carried out by receiving the instruction as a function call through an API exposed by the SLMPM to a system level function with arguments of the function call including the value (206) and the specific virtual address (204). The SLMPM may then identify an operation for the address in dependence upon the mappings of virtual address spaces and operations and identify a physical address associated with the specific virtual address as an address in shared memory residing on an accelerator. The SLMPM (146) may instruct the accelerator to perform the operation and store the result in the physical address (220) by sending a data communications message to the accelerator that includes an identification of the operation to perform, the physical address in shared memory, and the value from the host application program (166). In this way, the host computer may continue processing the host application in parallel with the accelerator performing the operation on the value and the contents of the physical address in shared memory.

Although data processing according to embodiments of the present invention is described largely in this specification as being executed entirely within a hybrid computing environment, readers of skill in the art will recognize that such data processing may be carried out in any computing environment including computing environments implemented in personal computers, workstations, laptops, handheld devices, personal digital assistant, so-called smart phones, global positioning satellite devices, and so on. That is, the hybrid computing environments described in detail in this specification are examples just one type of computing environment in which data processing may be carried out in accordance with embodiments of the present invention.

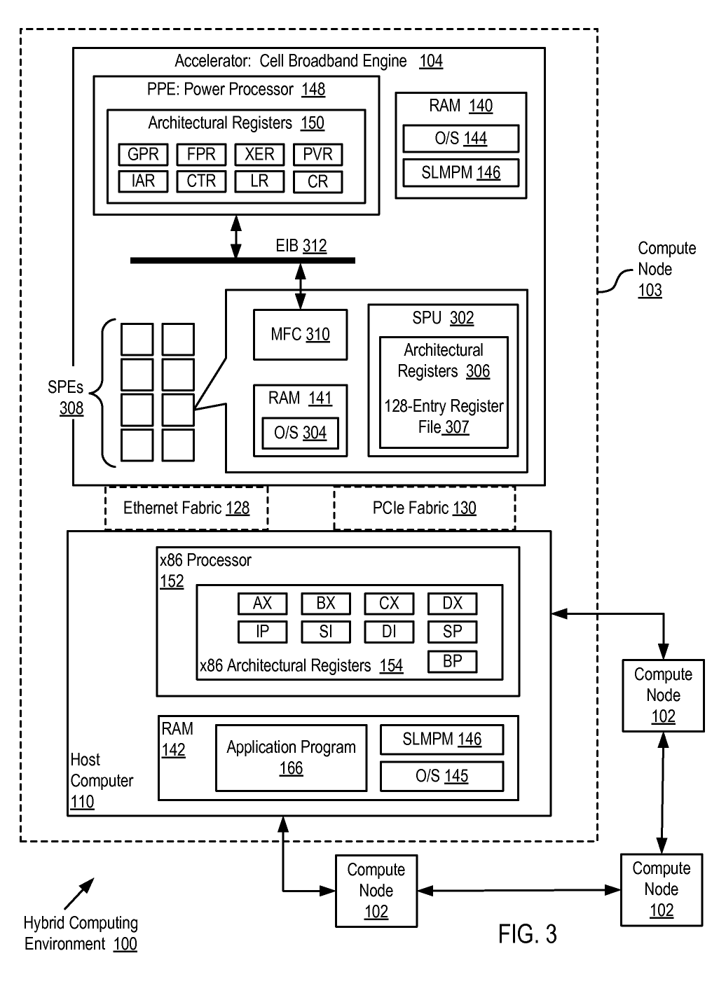

For further explanation, FIG. 3 sets forth a block diagram of a further exemplary hybrid computing environment (100) useful for data processing according to embodiments of the present invention. The hybrid computing environment of FIG. 3 is similar the hybrid computing environment of FIG. 2, including as it does, four compute nodes (102, 103), each of which includes a host computer (110) having a host computer architecture and an accelerator (104) having an accelerator architecture where the accelerator architecture is optimized, with respect to the host computer architecture, for speed of execution of a particular class of computing functions. The host computer (110) and the accelerator (104) are adapted to one another for data communications by a system level message passing module (146) and two or more data communications fabrics (128, 130) of at least two different fabric types. In the example of FIG. 3, the host computer (110) is adapted to accelerator (104) by an Ethernet fabric (128) and a PCIe fabric (130).

The host computer (110) as illustrated in the expanded view of the compute node (103) includes an x86 processor. An x86 processor is a processor whose architecture is based upon the architectural register set of the Intel x86 series of microprocessors, the 386, the 486, the 586 or Pentium™, and so on. Examples of x86 processors include the Advanced Micro Devices (‘AMD’) Opteron™, the AMD Phenom™, the AMD Athlon XP™, the AMD Athlon 64™, Intel Nehalam™, Intel Pentium 4, Intel Core 2 Duo, Intel Atom, and so on as will occur to those of skill in the art. The x86 processor (152) in the example of Figure illustrates a set of a typical architectural registers (154) found in many x86 processors including, for example, an accumulator register (‘AX’), a base register (‘BX’), a counter register (‘CX’), a data register (‘DX’), a source index register for string operations (‘SI’), a destination index for string operations (‘DI’), a stack pointer (‘SP’), a stack base pointer for holding the address of the current stack frame (‘BP’), and an instruction pointer that holds the current instruction address (‘IP’).

The accelerator (104) in the example of FIG. 3 is illustrated as a Cell Broadband Engine (‘CBE’) having a Cell Broadband Engine Architecture (‘CBEA’). A CBEA is a microprocessor architecture jointly developed by Sony Computer Entertainment, Toshiba, and IBM, an alliance known as “STI.” Microprocessors implemented according to the CBEA are sometimes referred to as ‘Cell’ processors or simply as CBEs. The CBEA combines a general-purpose POWER architecture core, a Power Processing Element (‘PPE’) (148), of modest performance with streamlined co-processing elements, called Synergistic Processing Elements (‘SPEs’) (308) which greatly accelerate multimedia and vector processing applications, as well as many other forms of dedicated computation. The CBE architecture emphasizes efficiency/watt, prioritizes bandwidth over latency, and favors peak computational throughput over simplicity of program code.

The accelerator (104) of FIG. 3, implemented as a CBE, includes a main processor (148) that in this example is a Power Processing Element (‘PPE’), eight fully-functional co-processors called SPEs (308), and a high-bandwidth circular data bus connecting the PPE and the SPEs, called the Element Interconnect Bus (‘EIB’) (312). The PPE (148) is a POWER architecture processor with a two-way multithreaded core acting as a controller for the eight SPEs (308). The term “POWER architecture” here refers to IBM's different generations of processor architectures, a broad term including all products based on POWER, PowerPC and Cell architectures. The architectural registers (150) of the PPE (148) of the CBE accelerator (104) therefore are different from those of the x86 processor (152) of the host computer (110). The PPE (148) of FIG. 3 includes an example set of architectural registers (150) of the POWER architecture, including 32 general purpose registers (‘GPRs’), 32 floating point registers (‘FPRs’), a fixed-point exception register (‘XER’), a count register (‘CTR’), a Condition register (‘CR’), an instruction address register (‘IAR’), a link register (‘LR’), and a processor version register (‘PVR’).

The SPEs (308) handle most of the computational workload of the CBE (104). While the SPEs are optimized for vectorized floating point code execution, the SPEs also may execute operating systems, such as, for example, a lightweight, modified version of Linux with the operating system stored in local memory (141) on the SPE. Each SPE (308) in the example of FIG. 3 includes a Synergistic Processing Unit (‘SPU’) (302), and a Memory Flow Controller (‘MFC’) (310). An SPU (302) is a Reduced Instruction Set Computing (‘RISC’) processor with 128-bit single instruction, multiple data (‘SIMD’) organization for single and double precision instructions. In some implementations, an SPU may contain a 256 KB embedded Static RAM (141) for instructions and data, called local storage which is visible to the PPE (148) and can be addressed directly by software. Each SPU (302) can support up to 4 Gigabyte (‘GB’) of local store memory. The local store does not operate like a conventional CPU cache because the local store is neither transparent to software nor does it contain hardware structures that predict which data to load. The SPUs (302) also implement architectural registers (306) different from those of the PPE which include a 128-bit, 128-entry register file (307). An SPU (302) can operate on 16 8-bit integers, 8 16-bit integers, 4 32-bit integers, or 4 single precision floating-point numbers in a single clock cycle, as well as execute a memory operation.

The MFC (310) integrates the SPUs (302) in the CBE (104). The MFC (310) provides an SPU with data transfer and synchronization capabilities, and implements the SPU interface to the EIB (312) which serves as the transportation hub for the CBE (104). The MFC (310) also implements the communication interface between the SPE (308) and PPE (148), and serves as a data transfer engine that performs bulk data transfers between the local storage (141) of an SPU (302) and CBE system memory, RAM (140), through DMA. By offloading data transfer from the SPUs (302) onto dedicated data transfer engines, data processing and data transfer proceeds in parallel, supporting advanced programming methods such as software pipelining and double buffering. Providing the ability to perform high performance data transfer asynchronously and in parallel with data processing on the PPE (148) and SPEs (302), the MFC (310) eliminates the need to explicitly interleave data processing and transfer at the application level.

The SLMPM (146) in the example of FIG. 3 processes data in the hybrid computing environment (100) according to embodiments of the present invention by monitoring data communications performance for a plurality of data communications modes between the host computer (110) and the accelerator (104); receiving, from an application program (166) on the host computer (110), a request to transmit data according to a data communications mode from the host computer (110) to the accelerator (104); determining, in dependence upon the monitored performance, whether to transmit the data according to the requested data communications mode; and if the data is not to be transmitted according to the requested data communications mode: selecting, in dependence upon the monitored performance, another data communications mode for transmitting the data and transmitting the data according to the selected data communications mode.

The hybrid computing environment of FIG. 3 is an example of a computing environment configured for data processing according to embodiments of the present invention. Such data processing may include allocating, by an operating system for an application, a plurality of virtual address spaces, each virtual address space mapped to a same physical address space, each virtual address space associated with an operation; receiving, from the application, an instruction to store a value in a specific virtual address, the specific virtual address contained within one of the allocated virtual address spaces; identifying a physical address associated with the specific virtual address; performing, with the value and the contents of the identified physical address, the operation associated with the virtual address space containing the specific virtual address; and storing a result of the operation in the identified physical address.

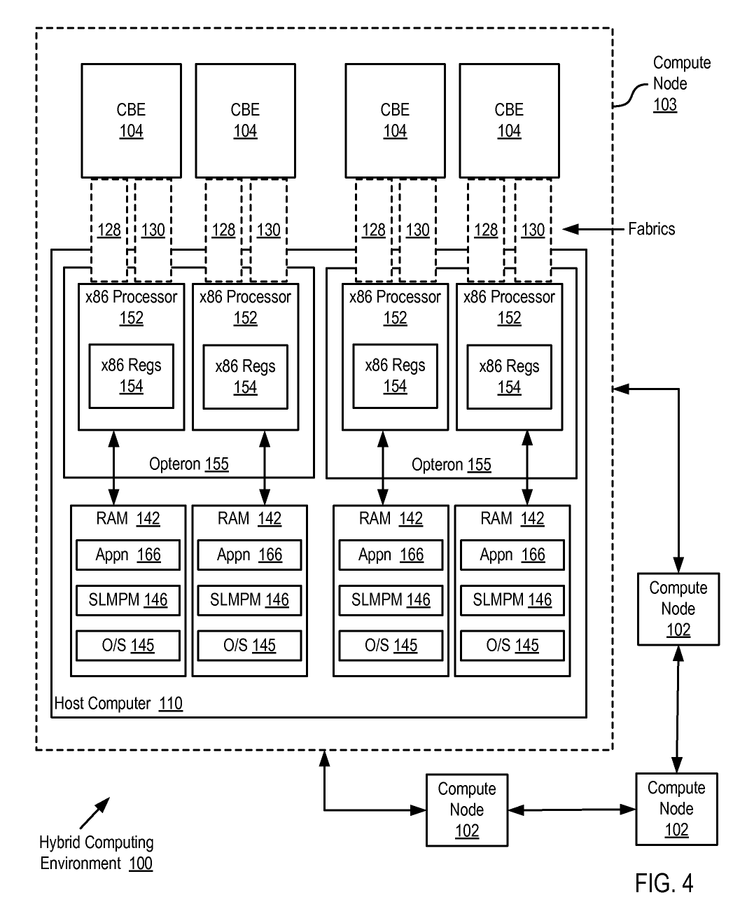

For further explanation, FIG. 4 sets forth a block diagram of a further exemplary hybrid computing environment (100) useful for data processing according to embodiments of the present invention. The hybrid computing environment of FIG. 4 is similar the hybrid computing environment of FIG. 2, including as it does, four compute nodes (102, 103), each of which includes a host computer (110) having a host computer architecture and one or more accelerators (104) each having an accelerator architecture where the accelerator architecture is optimized, with respect to the host computer architecture, for speed of execution of a particular class of computing functions. The host computer (110) and the accelerator (104) in the example of FIG. 4 are adapted to one another for data communications by a system level message passing module (146) and two or more data communications fabrics (128, 130) of at least two different fabric types. In the example of FIG. 4, the host computer (110) is adapted to accelerator (104) by an Ethernet fabric (128) and a PCIe fabric (130).

FIG. 4 illustrates an example of a hybrid computing environment similar to that implemented in the LANL supercomputer. The host computer (110), as illustrated by the expanded view of the compute node (103), implemented in the LANL supercomputer includes two AMD Opteron processors (155), each of which is a dual-core processor. Each of the cores (152) of the host computer (110) is illustrated in the example of FIG. 4 as a single, fully functional x86 processor core with each core having its own set of architectural registers (154). Each of the processor cores (152) in the example of FIG. 4 is operatively coupled to RAM (142) where an instance of an application program (166), an instance of the SLMPM (146), and an operating system (145) is stored. In the example of the LANL supercomputer, the SLMPM (146) is the Data Communication and Synchronization (‘DACS’) library improved according to embodiments of the present invention.

Each x86 processor core (152) in the example of FIG. 4 is adapted through an Ethernet (128) and PCIe (130) fabric to a separate accelerator (104) implemented as a CBE as described above with respect to FIG. 3. Each core (152) of each AMD Opteron processor (155) in the host computer (110) in this example is connected to at least one CBE. Although in this example the ratio of cores of the Opteron processors to CBEs (104) is one-to-one, readers of skill in the art will recognize that other example embodiments may implement different ratios of processor cores to accelerators such as, for example, one-to-two, one-to-three, and so on.

Each instance of the SLMPM (146) executing on each x86 processor core (152) in the example of FIG. 4 processes data in the hybrid computing environment (100) according to embodiments of the present invention by monitoring data communications performance across data communications modes between the host computer (110) and the accelerator (104) connected to the processor core (152); receiving, from the instance of the application program (166) executing on the processor core (152) of the host computer (110), a request to transmit data according to a data communications mode from the host computer (110) to the accelerator (104) connected to the processor core (152); determining, in dependence upon the monitored performance, whether to transmit the data according to the requested data communications mode; and if the data is not to be transmitted according to the requested data communications mode: selecting, in dependence upon the monitored performance, another data communications mode for transmitting the data and transmitting the data according to the selected data communications mode.

The hybrid computing environment of FIG. 4 is an example of a computing environment configured for data processing according to embodiments of the present invention. Such data processing may include allocating, by an operating system for an application, a plurality of virtual address spaces, each virtual address space mapped to a same physical address space, each virtual address space associated with an operation; receiving, from the application, an instruction to store a value in a specific virtual address, the specific virtual address contained within one of the allocated virtual address spaces; identifying a physical address associated with the specific virtual address; performing, with the value and the contents of the identified physical address, the operation associated with the virtual address space containing the specific virtual address; and storing a result of the operation in the identified physical address.

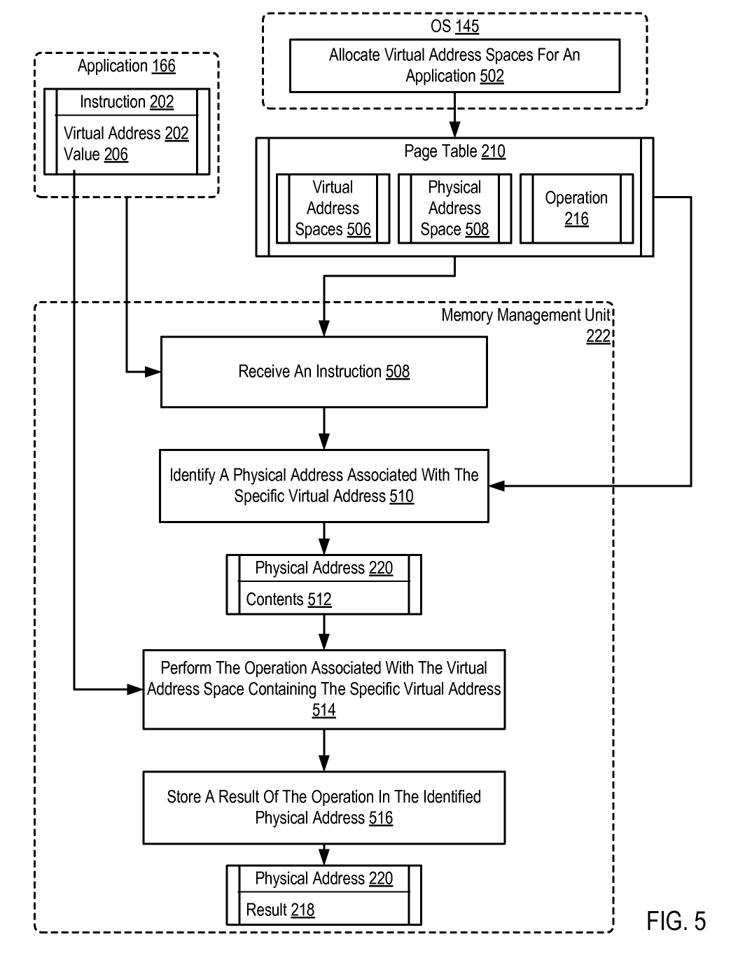

For further explanation, FIG. 5 sets forth a flow chart illustrating an exemplary method for data processing in a computing environment according to embodiments of the present invention. The method of FIG. 5 includes allocating (502), by an operating system (145) for an application (166), virtual address spaces (506). In the method of FIG. 5, each virtual address space (506) is mapped to a same physical address space (508). In the method of FIG. 5 the operating system maps such virtual address spaces (506) to a same physical address space (508) in a page table (210). Also in the method of FIG. 5, each virtual address space (506) is associated with an operation (216). Here the association of a virtual address space (506) and an operation (216) is recorded in the page table (210). The method of FIG. 5 also includes receiving (508), from the application (166), an instruction (202) to store a value (206) in a specific virtual address (202). In the method of FIG. 5, the specific virtual address (202) is contained within one of the allocated virtual address spaces (506). The method of FIG. 5 also includes identifying (510) a physical address (220) associated with the specific virtual address (202). The method of FIG. 5 also includes performing (514), with the value (206) and the contents (512) of the identified physical address (220), the operation (216) associated with the virtual address space (506) containing the specific virtual address (202). The method of FIG. 5 also includes storing (516) a result (218) of the operation (216) in the identified physical address (220).

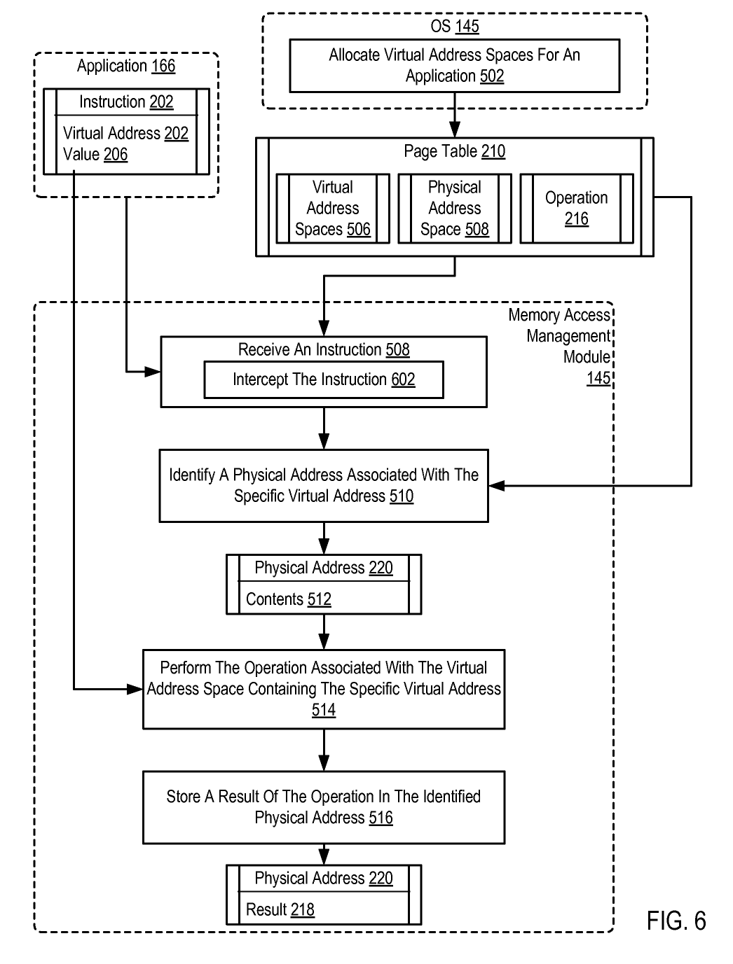

In the method of FIG. 5 the steps of receiving (508) the instruction (202), identifying (510) the physical address (220), performing (514) the operation (216), and storing (516) the result (218) of the operation (216) in the identified physical address (220) are carried out in computer hardware by a memory management unit (222). Readers of skill in the art will recognize that a hardware memory management unit (222) is only one example module which may be capable of carrying out such steps. In fact, such steps may be carried out by many other hardware or software modules. For further explanation, therefore, FIG. 6 sets forth a flow chart illustrating a further exemplary method for data processing in a computing environment according to embodiments of the present invention in which one or more steps of the method are carried out in software. The method of FIG. 6 is similar to the method of FIG. 5 including as it does allocating (502), by an operating system (145) for an application (166), virtual address spaces (506). each virtual address space (506) mapped to a same physical address space (508), each virtual address space (506) associated with an operation (216); receiving (508), from the application (166), an instruction (202) to store a value (206) in a specific virtual address (202), the specific virtual address (202) contained within one of the allocated virtual address spaces (506); identifying (510) a physical address (220) associated with the specific virtual address (202); performing (514), with the value (206) and the contents (512) of the identified physical address (220), the operation (216) associated with the virtual address space (506) containing the specific virtual address (202); and storing (516) a result (218) of the operation (216) in the identified physical address (220). The method of FIG. 6 differs from the method of FIG. 5 in that in the method of FIG. 6 the steps of receiving (508) the instruction (202), identifying (510) the physical address (220), performing (514) the operation (216), and storing (516) the result (218) of the operation (216) in the identified physical address (220) are carried out in computer software by a memory access management module (145). Also in the method of FIG. 6 receiving (508) the instruction (202) includes intercepting (602), by the memory access management module (145), the instruction (202) to store the value in the specific virtual address.

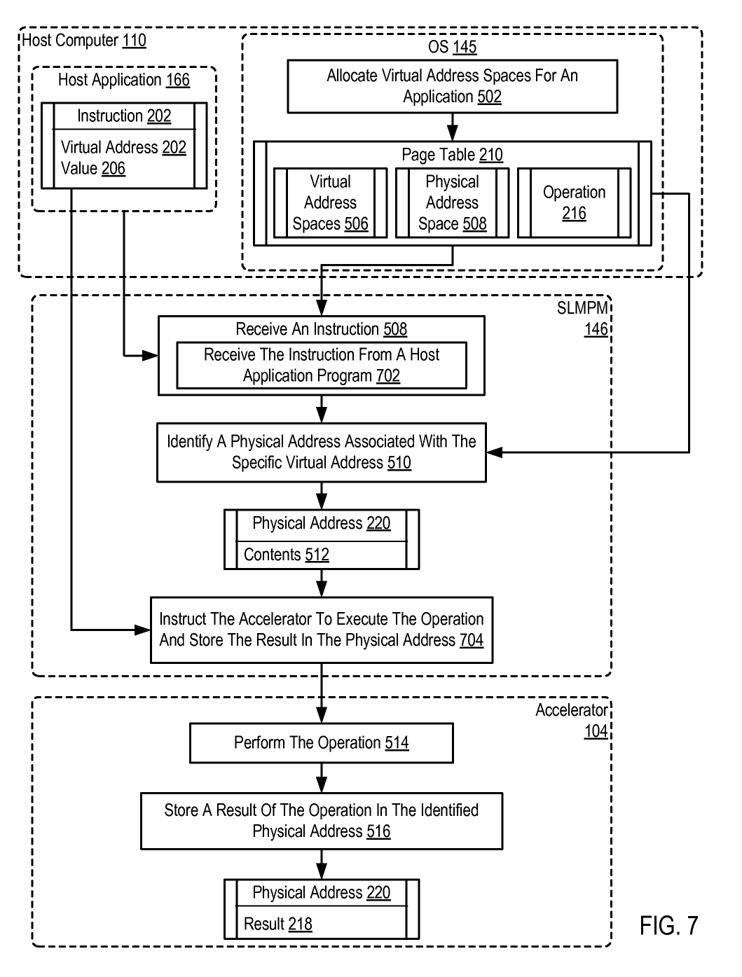

For further explanation, FIG. 7 sets forth a flow chart illustrating a further exemplary method for data processing in a computing environment according to embodiments of the present invention. The method of FIG. 7 is carried out in a hybrid computing environment similar to the hybrid computing environments described above in this specification. Such a hybrid computing environment includes a host computer (110 on FIG. 2) having a host computer architecture and an accelerator (104 on FIG. 2) having an accelerator architecture, the accelerator architecture optimized, with respect to the host computer architecture, for speed of execution of a particular class of computing functions, the host computer (110 on FIG. 2) and the accelerator (104 on FIG. 2) adapted to one another for data communications by an SLMPM (146 on FIG. 2) and, optionally, by two or more data communications fabrics (128, 130 on FIG. 2) of at least two different fabric types.

The method of FIG. 7 is similar to the method of FIG. 5 including as it does allocating (502), by an operating system (145) for an application (166), virtual address spaces (506). each virtual address space (506) mapped to a same physical address space (508), each virtual address space (506) associated with an operation (216); receiving (508), from the application (166), an instruction (202) to store a value (206) in a specific virtual address (202), the specific virtual address (202) contained within one of the allocated virtual address spaces (506); identifying (510) a physical address (220) associated with the specific virtual address (202); performing (514), with the value (206) and the contents (512) of the identified physical address (220), the operation (216) associated with the virtual address space (506) containing the specific virtual address (202); and storing (516) a result (218) of the operation (216) in the identified physical address (220). The method of FIG. 7 differs from the method of FIG. 5, however, in that in the method of FIG. 6 receiving (508), an instruction (202) includes receiving (702), by the system level message passing module (146), the instruction (202) from a host application program (166) executing on the host computer (110). The method of FIG. 7 also includes instructing (704), by the system level message passing module (146), the accelerator (104) to perform (514) the operation (216) and store (516) the result (218) in the identified physical address (220).

Exemplary embodiments of the present invention are described largely in the context of data processing in a fully functional computing environment, specifically a hybrid computing environment. Readers of skill in the art will recognize, however, that method aspects of the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of data processing in a computing environment, the method comprising:
allocating, by an operating system for an application, a plurality of virtual address spaces, each virtual address space mapped to a same physical address space, each virtual address space associated with an operation;
receiving, from the application, an instruction to store a value in a specific virtual address, the specific virtual address contained within one of the allocated virtual address spaces;
identifying a physical address associated with the specific virtual address;
performing, with the value and the contents of the identified physical address, the operation associated with the virtual address space containing the specific virtual address; and
storing a result of the operation in the identified physical address.

2. The method of claim 1 wherein receiving the instruction, identifying the physical address, performing the operation, and storing the result of the operation in the identified physical address are carried out in computer hardware by a memory management unit.

3. The method of claim 1 wherein:
receiving, from an application, an instruction to store a value in a specific virtual address further comprises intercepting, by a memory access management module, the instruction to store the value in the specific virtual address; and
identifying the physical address, performing the operation, and storing the result of the operation in the identified physical address are carried out in software by the memory access management module.

4. The method of claim 1 wherein the computing environment further comprises:
a hybrid computing environment that includes a host computer having a host computer architecture, an accelerator having an accelerator architecture, the accelerator architecture optimized, with respect to the host computer architecture, for speed of execution of a particular class of computing functions, the host computer and the accelerator adapted to one another for data communications by a system level message passing module.

5. The method of claim 4 wherein:
receiving, from an application, an instruction to store a value in a specific virtual address further comprises receiving, by the system level message passing module, the instruction from a host application program executing on the host computer; and
the method further comprises instructing, by the system level message passing module, the accelerator to perform the operation and store the result in the identified physical address.

6. The method of claim 4 wherein the host computer and the accelerator adapted to one another for data communications by two or more data communications fabrics of at least two different fabric types.

7. An apparatus for data processing in a computing environment, the apparatus comprising a computer processor, a computer memory operatively coupled to the computer processor, the computer memory having disposed within it computer program instructions capable of:
allocating, by an operating system for an application, a plurality of virtual address spaces, each virtual address space mapped to a same physical address space, each virtual address space associated with an operation;
receiving, from the application, an instruction to store a value in a specific virtual address, the specific virtual address contained within one of the allocated virtual address spaces;
identifying a physical address associated with the specific virtual address;
performing, with the value and the contents of the identified physical address, the operation associated with the virtual address space containing the specific virtual address; and
storing a result of the operation in the identified physical address.

8. The apparatus of claim 7 wherein receiving the instruction, identifying the physical address, performing the operation, and storing the result of the operation in the identified physical address are carried out in computer hardware by a memory management unit.

9. The apparatus of claim 7 wherein:
receiving, from an application, an instruction to store a value in a specific virtual address further comprises intercepting, by a memory access management module, the instruction to store the value in the specific virtual address; and
identifying the physical address, performing the operation, and storing the result of the operation in the identified physical address are carried out in software by the memory access management module.

10. The apparatus of claim 7 wherein the computing environment further comprises:
a hybrid computing environment that includes a host computer having a host computer architecture, an accelerator having an accelerator architecture, the accelerator architecture optimized, with respect to the host computer architecture, for speed of execution of a particular class of computing functions, the host computer and the accelerator adapted to one another for data communications by a system level message passing module.

11. The apparatus of claim 10 wherein:
receiving, from an application, an instruction to store a value in a specific virtual address further comprises receiving, by the system level message passing module, the instruction from a host application program executing on the host computer; and
the apparatus further comprises computer program instructions capable of instructing, by the system level message passing module, the accelerator to perform the operation and store the result in the identified physical address.

12. The apparatus of claim 10 wherein the host computer and the accelerator adapted to one another for data communications by two or more data communications fabrics of at least two different fabric types.

13. A computer program product for data processing in a computing environment, the computer program product disposed in a computer readable, signal bearing medium, the computer program product comprising computer program instructions capable of:
allocating, by an operating system for an application, a plurality of virtual address spaces, each virtual address space mapped to a same physical address space, each virtual address space associated with an operation;
receiving, from the application, an instruction to store a value in a specific virtual address, the specific virtual address contained within one of the allocated virtual address spaces;
identifying a physical address associated with the specific virtual address;
performing, with the value and the contents of the identified physical address, the operation associated with the virtual address space containing the specific virtual address; and
storing a result of the operation in the identified physical address.

14. The computer program product of claim 13 wherein receiving the instruction, identifying the physical address, performing the operation, and storing the result of the operation in the identified physical address are carried out in computer hardware by a memory management unit.

15. The computer program product of claim 13 wherein:
receiving, from an application, an instruction to store a value in a specific virtual address further comprises intercepting, by a memory access management module, the instruction to store the value in the specific virtual address; and
identifying the physical address, performing the operation, and storing the result of the operation in the identified physical address are carried out in software by the memory access management module.

16. The computer program product of claim 13 wherein the computing environment further comprises:
a hybrid computing environment that includes a host computer having a host computer architecture, an accelerator having an accelerator architecture, the accelerator architecture optimized, with respect to the host computer architecture, for speed of execution of a particular class of computing functions, the host computer and the accelerator adapted to one another for data communications by a system level message passing module.

17. The computer program product of claim 16 wherein:
receiving, from an application, an instruction to store a value in a specific virtual address further comprises receiving, by the system level message passing module, the instruction from a host application program executing on the host computer; and
the computer program product further comprises computer program instructions capable of instructing, by the system level message passing module, the accelerator to perform the operation and store the result in the identified physical address.

18. The computer program product of claim 16 wherein the host computer and the accelerator adapted to one another for data communications by two or more data communications fabrics of at least two different fabric types.

19. The computer program product of claim 13 wherein the signal bearing medium comprises a recordable medium.

20. The computer program product of claim 13 wherein the signal bearing medium comprises a transmission medium.
